(19) United States
(12) Patent Application Publication
(10) Pub. No.: US 2005/0008217 A1
(43) Pub. Date: Jan. 13, 2005

(54) Method for defect segmentation in features on semiconductor substrates

(75) Inventors: Thin Van Luu, Wetzlar (DE); Bernd Jungmann, Marburg (DE); Detlef Michelsson, Wetzlar-Naunheim (DE)

Correspondence Address: FOLEY AND LARDNER;SUITE 500, 3000 K STREET NW, WASHINGTON, DC, 20007, US

(73) Assignee: LEICA MICROSYSTEMS SEMICONDUCTOR GmbH

(21) Appl. No.: 10/883,823

(22) Filed: Jul. 6, 2004

(30) Foreign Application Priority Data
Jul. 11, 2003 (DE) 103 31 593.4

(51) Int. Cl. G06K 9/00

(52) U.S. Cl. 382/145

(57) ABSTRACT

A method for defect segmentation in features on semiconductor substrates is disclosed. After acquisition of an image of a semiconductor substrate, identical features or feature elements are subtracted from one another. The resulting difference function is compared with an upper and a lower threshold in order to identify defects.

### CROSS REFERENCE TO RELATED APPLICATIONS

This application claims priority of the German patent application 103 31 593.4 which is incorporated by reference herein.

### FIELD OF THE INVENTION

The invention concerns a method for defect segmentation in features on semiconductor substrates.

### BACKGROUND OF THE INVENTION

Defects can be accentuated by determining the difference between images of equivalent semiconductor features. The difference image is disrupted by noise. Defects can be distinguished from defect-free regions using an (adaptive) threshold. Dilation and erosion of the defect image does not always produce the desired result. Images of continuous faults, e.g. scratches or bubbles, on semiconductor structures can result in various deviations from a reference image. The amplitude of the fault signal can vary depending on the substrate. A threshold determines which fault signal is to be evaluated as a fault. If that threshold is set too low, pseudo-defects then occur as a result of the noise. If it is set too high, it may happen that continuous defects are broken down by noise into numerous individual defects.

In semiconductor manufacturing, wafers are sequentially processed in a plurality of process steps during the manufacturing process. With increasing integration density, requirements in terms of the quality of the features configured on the wafers become more stringent. To allow the quality of the configured features to be checked, and any defects to be found, a corresponding requirement exists in terms of the quality, accuracy, and reproducibility of the components and process steps used on the wafers. This means that during production of a wafer, with the many process steps and many layers of photoresist, or the like, to be applied, early and reliable detection of defects in the individual features is particularly important. As a result of the patterning, in certain regions of the patterning faults may occur that are discovered and detected by a comparison of mutually corresponding features or feature elements.

### SUMMARY OF THE INVENTION

It is the object of the invention to create a method that makes possible a segmentation of defects in difference images of equivalent features on semiconductor substrates, and simultaneously prevents the breakdown of large defects into multiple individual defects.

This object is achieved by a method for the inspection of features on semiconductor substrates, characterized by the following steps:
acquiring an image of at least one semiconductor substrate that encompasses a plurality of elements having identical recurring features;
creating a difference profile from two mutually corresponding features or feature regions of the imaged semiconductor substrate; and
determining a defect on the basis of a lower threshold and an upper threshold, both being spaced away from and parallel to one another.

It has proven advantageous if firstly an image of at least one semiconductor substrate is acquired, the image encompassing a plurality of elements that have identical recurring features. From the acquired images or image data, a difference function is determined from two mutually corresponding features or feature regions. The difference profile is compared with two thresholds in order to allow regions with a high difference amplitude to be classified as fault regions. A possible fault region is determined by the fact that the value of the difference function everywhere exceeds the lower threshold. It qualifies as a real defect region, however, only if the difference profile also exceeds the upper threshold at at least one point in that region. The fault regions, their extent, and their property of being deemed real, are automatically calculated using a computer program that is implemented in a computer of the system.

The lower threshold defines, by intersections with the peaks of the difference profile, at least one region in the lower threshold that indicates possible defects. Application of the upper threshold allows regions in the upper threshold to be determined by way of intersections with the peaks of the difference profile, the possible defects being characterized as real defects if, for that purpose, the respective peak of the difference profile exceeds the lower threshold, and thus the region in the upper threshold lies above the region in the lower threshold.

### BRIEF DESCRIPTION OF THE DRAWINGS

The subject matter of the invention is depicted schematically in the drawings and will be described below with reference to the Figures, in which:

FIG. 1 schematically depicts a system for detecting faults on wafers or patterned semiconductor substrates;

FIG. 2a depicts the manner in which the images or image data of a wafer are acquired;

FIG. 2b is a schematic plan view of a wafer;

FIG. 3 schematically shows a comparison of two mutually corresponding features on a semiconductor substrate;

FIG. 4 schematically depicts a pattern element with no defects;

FIG. 5 schematically depicts a pattern element having several defects;

FIG. 6 schematically depicts the difference between what is depicted in FIG. 4 and in FIG. 5;

FIG. 7 schematically depicts the difference with a section line along which the determination of the defects is explained;

FIG. 8 schematically depicts the application of the lower threshold to the difference profile;

FIG. 9 schematically depicts the application of the upper threshold to the difference profile;

FIG. 10 depicts a conventional threshold according to the existing art that is used in order to evaluate the difference signal with regard to defects; and

FIG. 11 depicts the same difference signal as in FIG. 10, segmentation being performed here by means of a dual threshold.

### DETAILED DESCRIPTION OF THE INVENTION

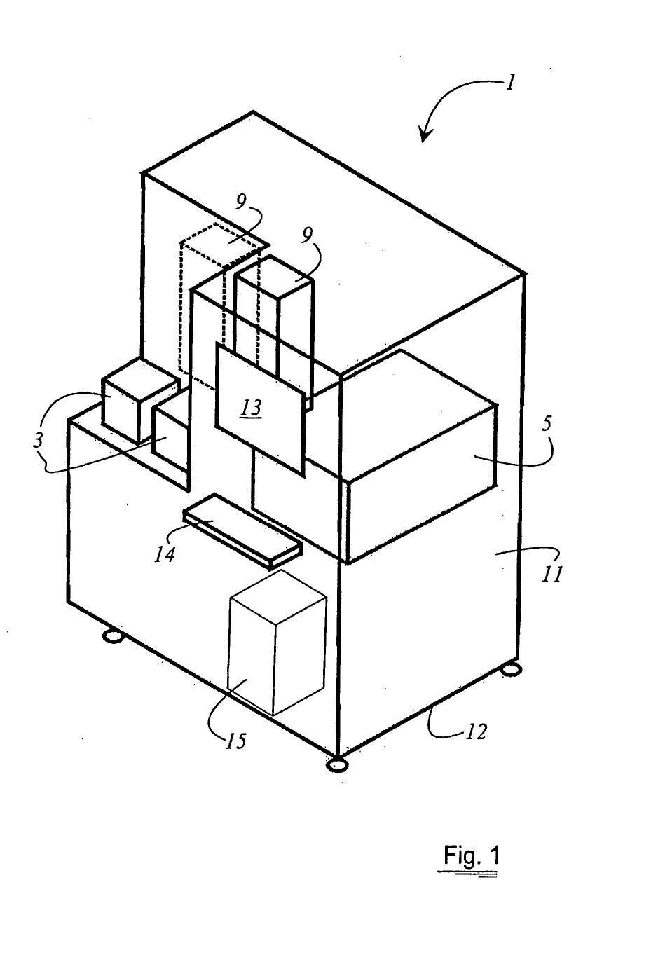

FIG. 1 shows a system 1 for the inspection of features on semiconductor substrates. System 1 comprises, for example, at least one cassette element 3 for the semiconductor substrates or wafers. In a measurement unit 5, images or image data of the individual wafers or patterned semiconductor substrates are acquired. A transport mechanism 9 is provided between cassette element 3 for the semiconductor substrates or wafers and measurement unit 5. System 1 is enclosed by a housing 11, housing 11 defining a base outline 12. Also integrated into system 1 is a computer 15 that receives and processes the images or image data of the individual measured wafers. System 1 is equipped with a display 13 and a keyboard 14. By means of keyboard 14, the user can input data in order to control system 1, or can also make parameter inputs in order to evaluate the image data of the individual wafers. On display 13, several user interfaces are displayed to the user of the system.

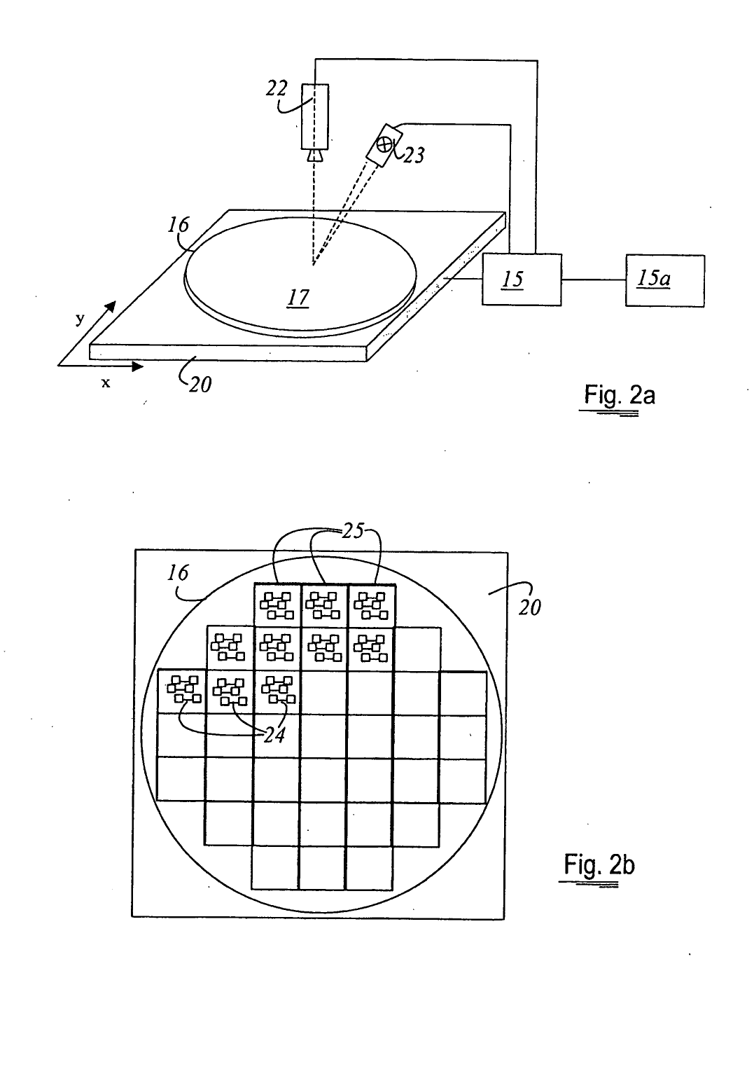

FIG. 2a is a schematic view of the manner in which images and/or image data of a wafer 16 are sensed. Wafer 16 is placed on a stage 20 that is movable in housing 11 of system 1 in a first direction X and a second direction Y. First and second direction X, Y are arranged perpendicular to one another. An image acquisition device 22 is provided above surface 17 of wafer 16, the image field of image acquisition device 22 being smaller than the entire surface 17 of wafer 16. In order to sense the entire surface 17 of wafer 16 with image acquisition device 22, wafer 16 is scanned in meander fashion. The successively sensed individual image fields are assembled into an overall image of surface 17 of a wafer 16. This is done also using computer 15 provided in housing 11. In order to produce a relative motion between stage 20 and image acquisition device 22, an X-Y scanning stage that can be displaced in the coordinate directions X and Y is used in this exemplary embodiment. Image acquisition device 22 is here installed immovably with respect to stage 20. Conversely, of course, stage 2 can also be installed immovably, and image acquisition device 22 can be moved over wafer 16 in order to acquire images. Also possible is a combination of motion of image acquisition device 22 in one direction and of stage 20 in the direction perpendicular thereto. A variety of systems can be used as image acquisition devices 22. On the one hand, both area cameras and linear cameras, which create microscopic or macroscopic images, can be used. The resolution of the camera is generally coordinated with the imaging optical system, e.g. the objective of a microscope or macroscope. For macroscopic images, the resolution is e.g. 50 μm per pixel. Wafer 16 is illuminated with an illumination device 23 which illuminates at least regions on wafer 16 that correspond to the image field of image acquisition device 22. The concentrated illumination, which moreover can also be pulsed with a flash lamp, allows images to be acquired on the fly, i.e. with stage 20 or image acquisition device 22 being displaced without stopping to acquire the image. This allows a high wafer throughput. It is also possible, of course, to stop the relative motion between stage 20 and image acquisition device 22 for each image acquisition, and also to illuminate wafer 16 over its entire surface 17. Stage 20, image acquisition device 22, and illumination device 23 are controlled by computer 15. The acquired images can be stored by computer 15 in a memory 15a, and also retrieved again therefrom as necessary. As a rule, the wafer is moved beneath image acquisition device 22. It is also conceivable, however, for image acquisition device 22 to be moved relative to the wafer. This motion is continuous. The individual images are achieved by the fact that a shutter is opened and a corresponding flash is triggered. The flash is triggered as a function of the relative position of the wafer, which is reported by way of corresponding position parameters of the stage that moves the wafer.

FIG. 2b shows a plan view of a wafer 16 that is placed onto a stage 20. Layers are applied onto wafer 16 and are then patterned in a further operation. A patterned wafer encompasses a plurality of elements 25 that, as a rule, comprise features 24 that are identical and recur in all elements 25.

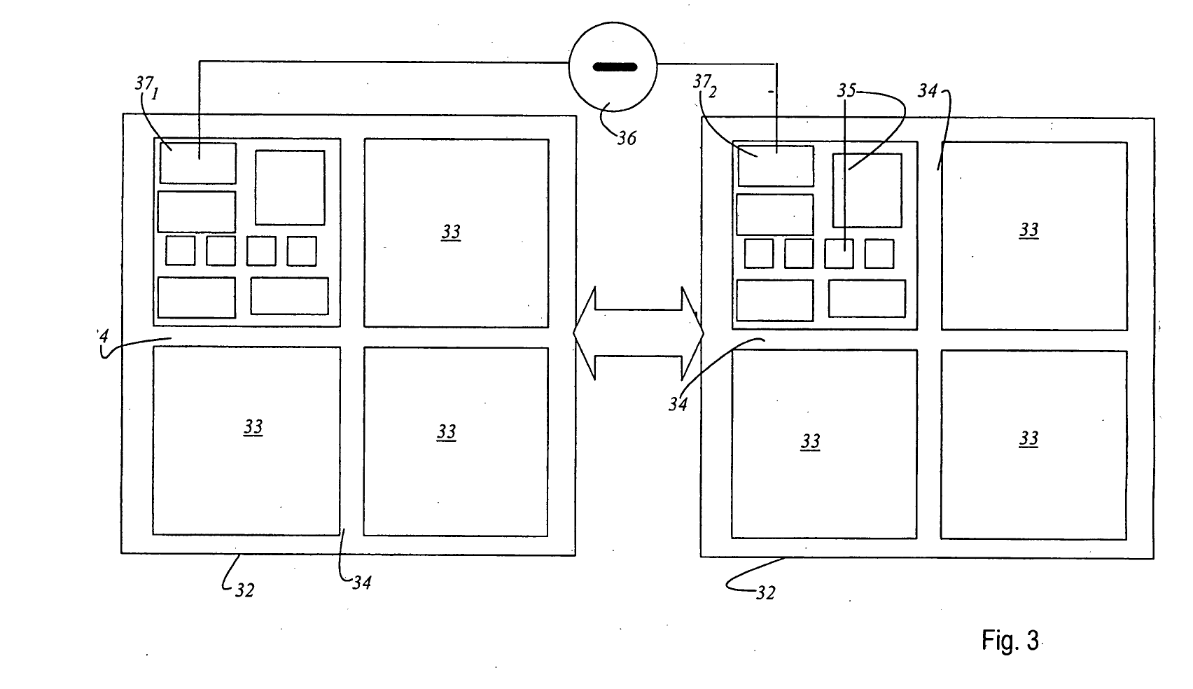

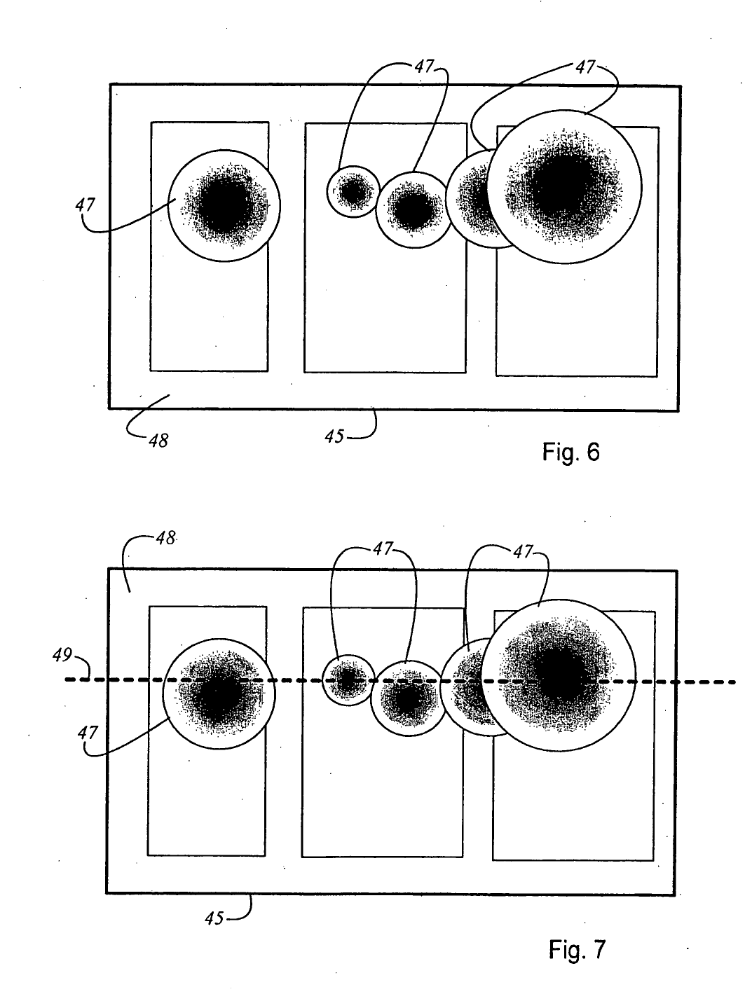

As depicted in FIG. 3, a patterned semiconductor wafer or a semiconductor substrate comprises multiple stepper area windows (SAWs) 32 that in turn contain multiple dice 33. “Streets” 34 are provided between dice 33. A certain number of dice are exposed simultaneously using a stepper. The same recurring features or pattern elements 35 are present in the various dice 33. A difference function 55 (see FIG. 6 or FIG. 7) is obtained by subtraction 36 of the image data of a first pattern element 37₁ from a second corresponding pattern element 37₂. Identical features are always compared to one another for the determination of difference function 55. If a fault is present on a pattern element, this results in a fluctuation or peak 70 in difference function 55.

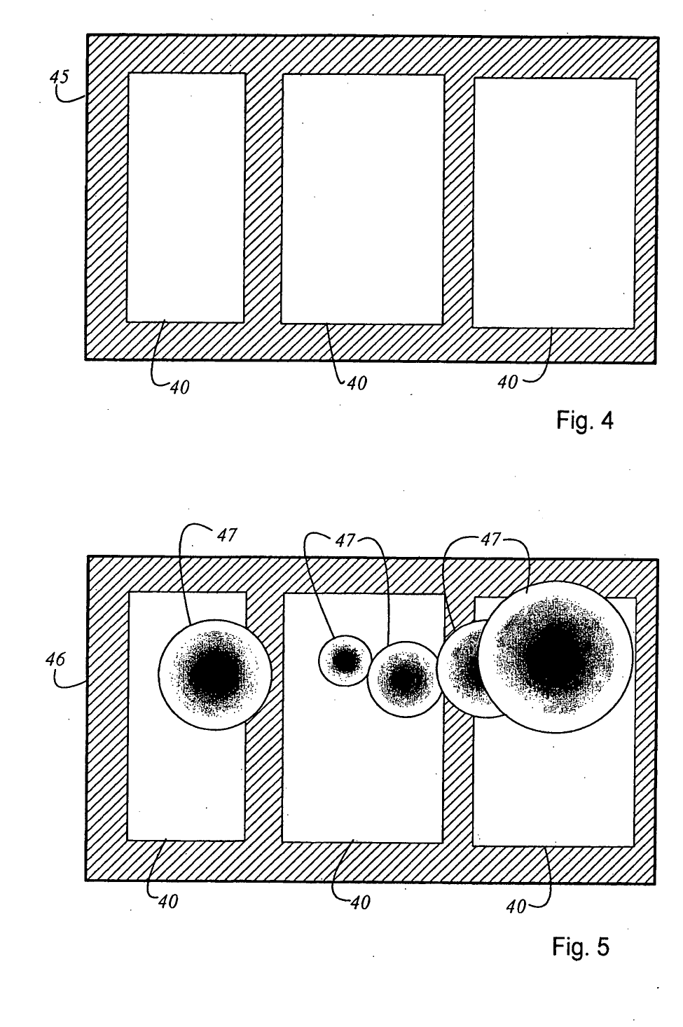

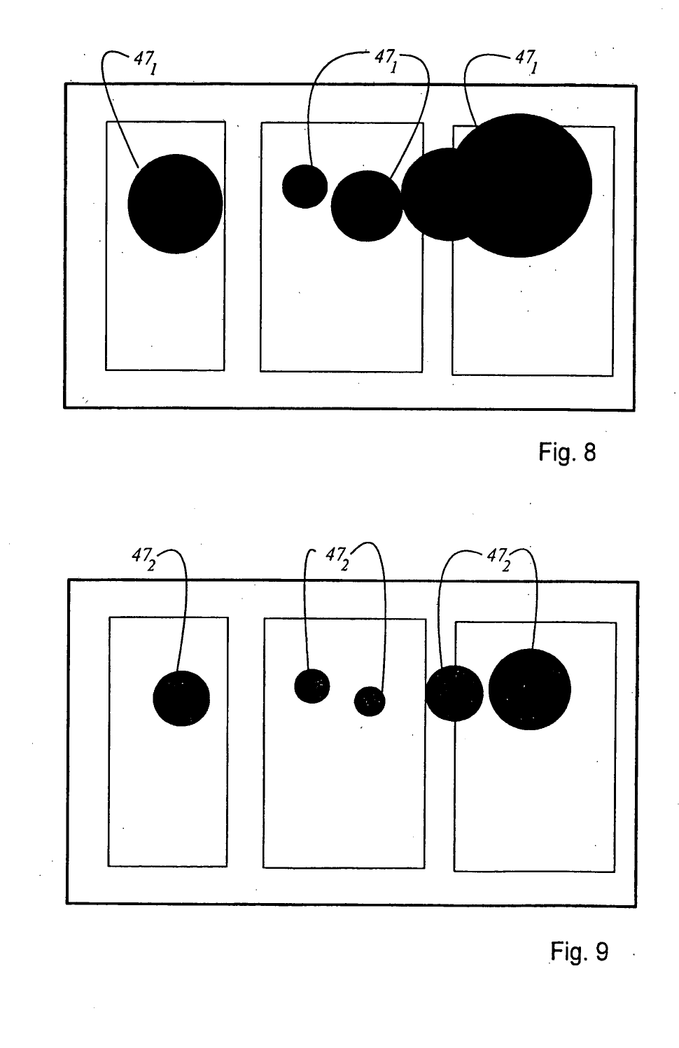

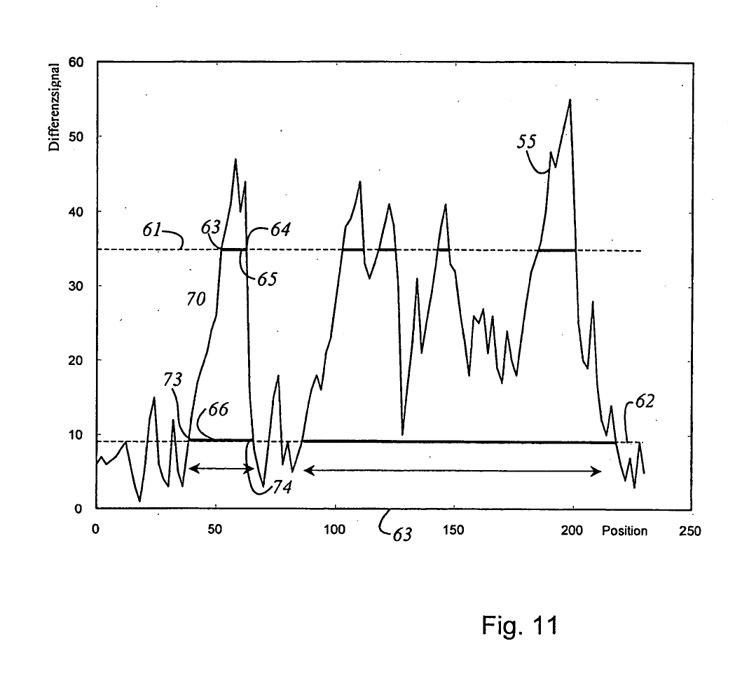

FIG. 4 shows, by way of example, a pattern element 45 that encompasses several sub-elements 40. Pattern element 45 is free of faults. FIG. 5 shows a pattern element 46 that encompasses several faults or defects 47. FIG. 6 is a schematic depiction of the difference between pattern element 45 (without faults) and pattern element 46 (with faults 47). Difference image 48 substantially comprises the background and faults 47, which emerge more clearly as a result of the differentiation. In FIG. 7, a line 49 is drawn to represent, by way of example, a section line along which an exemplifying graphical depiction of difference profile 55 (a brightness profile) is reproduced in FIG. 8 and FIG. 9, and to illustrate application of the lower and upper thresholds. The brightness profile of the difference image is acquired along line 49. FIG. 8 depicts the application of a lower threshold 62 (see FIG. 11) to difference image 48. The intersection of lower threshold 61 with difference image 48 emphasizes faults 47, and the extent of fault 47 at the level of lower threshold 62 is depicted as a first uniform, at least partly continuous surface 47₁. When upper threshold 61 in FIG. 9 is used, faults 47 are emphasized and the extent of fault 47 at the level of upper threshold 61 is depicted as a second uniform, at least partly continuous surface 47₂.

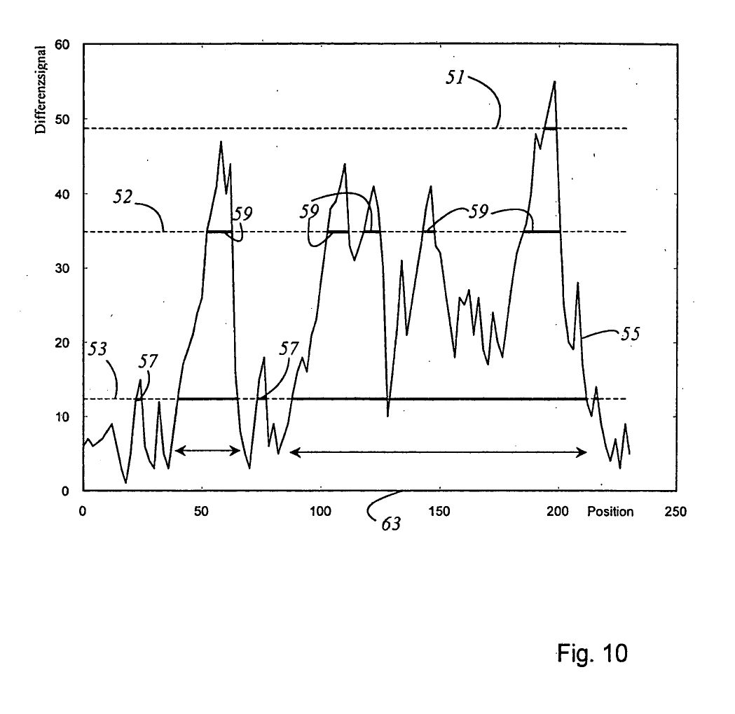

FIGS. 10 and 11 illustrate more clearly the manner in which the defects are ascertained. The three-dimensional difference profile or difference image along line 49 from FIG. 7 is depicted for that purpose by way of example (a projection of the difference profile onto the drawing plane being depicted for illustrative purposes). FIG. 10 shows the determination of a defect by means of a single threshold. Detection of a defect depends on the distance of the threshold from abscissa 63. A first threshold 51, second threshold 52, and third threshold 53 are depicted, each leading to a different result upon detection of a defect. When one threshold 51, 52, or 53 is used, correct segmentation of the defects in the context of a given difference signal 55 (as shown in FIG. 10) is not possible. For example, if first threshold 51 located farthest away from abscissa 63 is selected, then not all defects will be found. With third threshold 53, which is at the shortest distance from the abscissa, all defects are found but small fluctuations in difference signal 55 additionally result in incorrect detections, as labeled with the number 57 in FIG. 10. For second threshold 52, its distance from the abscissa is selected in such a way that incorrect detections do not occur, but the detected defects break down into a plurality of individual defects labeled with the number 59 in FIG. 10.

FIG. 1 shows the same difference signal 55 as in FIG. 10. Here the defects are segmented and detected by means of an upper threshold 61 and a lower threshold 62. In the depiction selected in FIG. 11, upper and lower thresholds 61 and 62 are reproduced as lines. It is self-evident to one skilled in the art that when the thresholds are applied in a three-dimensional defect profile, the respective threshold becomes a plane. The defect profile can moreover encompass more than three dimensions.

Upper and lower thresholds 61 and 62 are parallel to abscissa 63. The distance between them, and their distances from abscissa 63, can be defined by the user. The user utilizes, for example a mouse (not depicted) or keyboard 14 to move upper and lower thresholds 61 and 62 into positions favorable for the detection of defects. The user can also input a numerical value in the user interface and thereby define the positions of first and second thresholds 61 and 62 with respect to abscissa 63.

Two thresholds are considered in the example depicted in FIG. 11. The regions in which the difference profile exceeds lower threshold 62 are shown in FIG. 8 and marked accordingly; the regions in which the difference profile exceeds upper threshold 61 are shown in FIG. 9. Only one peak 70 of difference profile 55 will be singled out for description. Upper threshold 61 intersects difference profile 55 at, among others, a first and a second intersection point 63 and 64, whereas lower threshold 62 intersects difference profile 55 at the corresponding intersection points 73 and 74. A real defect exists between intersection points 73 and 74, since within region 66 there are points at which the upper threshold is exceeded by peak 70 of difference profile 55, namely in the vicinity of region 65 between points 63 and 64.

Incorrect detections 57, as evident e.g. from FIG. 10, are thus not detected as defects. The defects become somewhat larger as a result of upper and lower thresholds 61 and 62. This is not a disadvantage, however, since more information is thus available for later classification of the defects. With the use of upper and lower thresholds 61 and 62, breakdown into multiple individual defects can be prevented. Upper threshold 61 determines whether any defect at all is present. A defect is present only when at least one peak 70 of difference profile 55 exceeds upper threshold 61. Lower threshold 62 determines the extent of the defect. Lower threshold 62 is evaluated in all directions of the selected pattern element. Merging of two individual defects, in cases where the interstice is characterized by a very small difference signal, can thus be prevented. Individual defects are likewise combined when the difference between them lies below upper threshold 61 and above lower threshold 62 solely as a result of noise. A further variant of this principle consists in adapting lower threshold 62 as a function of the distance from the nearest point above upper threshold 61.

1. A method for the inspection of features on semiconductor substrates, characterized by the following steps:
acquiring an image of at least one semiconductor substrate that encompasses a plurality of elements having identical recurring features;
creating a difference profile from two mutually corresponding features or feature regions of the imaged semiconductor substrate; and
determining a defect on the basis of a lower threshold and an upper threshold, both being spaced away from and parallel to one another.

2. The method as defined in claim 1, wherein the difference profile forms a plurality of peaks.

3. The method as defined in claim 2, wherein the lower threshold defines, by way of intersections with the peaks of the difference profile, at least one region in the lower threshold that indicates possible defects.

4. The method as defined in claim 3, wherein the upper threshold defines regions in the upper threshold by way of intersections with the peaks of the difference profile, the possible defects being characterized as real defects if, for that purpose, the respective peak of the difference profile exceeds the upper threshold, and the region in the upper threshold thus lies above the region in the lower threshold.

5. The method as defined in claim 4, wherein the possible and real defects are calculated automatically by a computer program.
